(19) United States
(12) Patent Application Publication
(10) Pub. No.: US 2004/0105002 A1
(43) Pub. Date: Jun. 3, 2004

(54) Car A/V playback device

(76) Inventors: Wen-Shiung Chen, Shindian City (TW); Tsang-Yuan Liu, Shulin City (JP); Sam Hsieh, Taipei (TW)

Correspondence Address: RABIN & BERDO, P.C., Suite 500, 1101 14th Street, N.W., Washington, DC, 20005, US

(21) Appl. No.: 10/307,913

(22) Filed: Dec. 3, 2002

(51) Int. Cl. H04N 7/18; H04N 9/47

(52) U.S. Cl. 348/148; 386/46

(57) ABSTRACT

A car A/V playback device includes at least a signal-processing unit for compressing and storing input A/V signals as well as decompressing and reproducing stored A/V signals; a data-access unit allowing the signal-processing unit to do real-time access of signals stored therein; and a control unit for controlling modes in which the signal-processing unit and the data-access unit process signals. The car A/V playback device can be connected to a personal computer or a cable television to download a large quantity of musical works existed in the form of MP3 or CD, television programs, and pictures stored on VCD and DVD for storage on the device and direct playback on a car without the need of mounting VCD and DVD players on the car.

### BACKGROUND OF THE INVENTION

The present invention relates to a car A/V playback device, and more particularly to a car A/V playback device that can be connected to a personal computer or a cable television to download and store a large quantity of musical works existed in the form of MP3 or CD, television programs, and pictures stored on VCD and DVD, and used with other in-car A/V peripherals for direct playback of the stored musical works and pictures on a car without the need of mounting VCD and/or DVD players on the car.

With the currently largely improved living quality, people demand for increasingly upgraded material life, and the wide use of cars among people has become an index thereof. The car currently accepted by people must not only be comfortable and safe for driving, but also be equipped with A/V playback equipment to provide high-quality environment in driving. A/V playback equipment for car, such as VCD and DVD players, must work with a compact disk (CD) selector to select from a limited number of compact disks stored in the CD selector the desired compact disks for playback. Typically, each CD selector can store only ten or a few more compact disks therein. And, in the case of VCD and DVD, each picture would usually require at least two disks. That is, the number of VCD and DVD pictures that can be stored in one CD selector is very small. It is very troublesome to change the compact disks in the CD selector one by one. Another problem encountered by the conventional A/V equipment on car is the temperature and humidity in the car that are usually higher than room temperature to cause growth of molds on the compact disks having been stored in the CD selector for a prolonged time. The compact disk with molds would in turn result in a contaminated and even failed optical laser reading head to seriously destruct the whole A/V playback equipment.

A still further problem encountered by the conventional A/V playback equipment on car is vibration of the playback equipment during reproduction of music or picture. Although a shock-absorbing structure may be provided to the playback equipment on car, it is impossible to always prevent the playback equipment on car from vibration when the car is moving on a bumpy road. Playback would be interrupted to adversely affect the effect of the A/V playback equipment when it is constantly vibrated. Moreover, the laser reading head of the A/V playback equipment on car tends to jerk when the car is moving and requires relocation to find the correct track of reading after such jerking. Frequent corrections and adjustments of the A/V playback equipment on car would result in increased rate of failure thereof.

It is therefore tried by the inventor to develop an improved car A/V playback device to overcome the problems encountered by the conventional A/V playback equipment on car.

### SUMMARY OF THE INVENTION

A primary object of the present invention is to provide a car A/V playback device that can be connected to a personal computer or a cable television to download and store a large quantity of musical works existed in the form of MP3 or CD, television programs, and pictures stored on VCD and DVD, and used with other in-car A/V peripherals for direct playback of the stored musical works and pictures on a car without the need of mounting VCD and/or DVD players on the car.

To achieve the above and other objects, the car A/V playback device of the present invention mainly includes a signal-processing unit for compressing and storing input A/V signals as well as decompressing and reproducing stored A/V signals; a data-access unit allowing the signal-processing unit to do real-time access of signals stored therein; and a control unit for controlling modes in which the signal-processing unit and the data-access unit process signals.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a systematic block diagram of the car A/V playback device of the present invention;

FIG. 2 is a perspective view of the car A/V playback device according to a preferred embodiment of the present invention;

FIG. 3 is a block diagram showing a first example of operation of the present invention; and

FIG. 4 is a block diagram showing a second example of operation of the present invention.

### DETAILED DESCRIPTION OF THE PREFERRED EMBODIMENTS

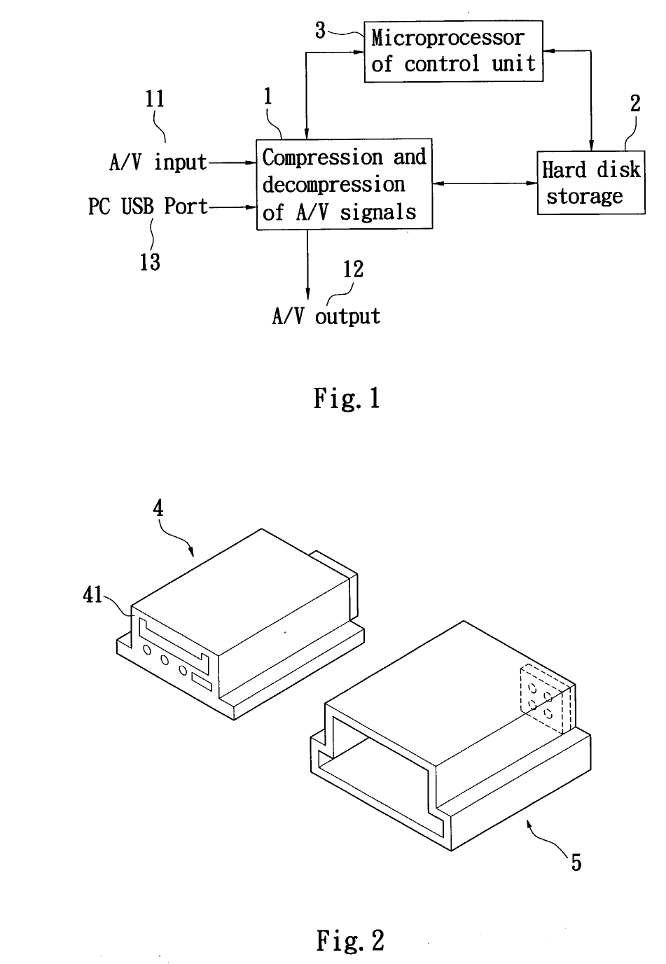

Please refer to FIG. 1 that is a systematic block diagram of a car A/V playback device according to the present invention. As shown, the car A/V playback device includes at least a signal-processing unit 1, a data-access unit 2, and a control unit 3.

The signal-processing unit 1 includes an A/V input 11, an A/V output 12, and a USB port 13 for connecting to external peripherals to input (i.e., to store) and output (i.e., to reproduce) A/V signals. The signal-processing unit 1 is able to compress the input signals for storing therein and decompress the stored signals for output or playback.

The data-access unit 2 is a high-capacity hard disk and can be internally divided into a music zone, a picture zone, and a driver zone. Signals stored in the data-access unit 2 are available for real-time access by the signal-processing unit 1.

The control unit 3 is adapted to control modes in which the signal-processing unit 1 and the data-access unit 2 process signals, and mainly includes a microprocessor to do related sorting and logic operation.

The above-mentioned units 1, 2, and 3 are mounted in a housing 4 shown in FIG. 2, which is a perspective view of the car A/V playback device of the present invention. The housing 4 is provided at a front side with a panel 41, on which a plurality of function keys are provided. An infrared receiver may be optionally provided on the front panel 41 to enable operation of the car A/V playback device with an infrared remote controller to select a musical work or a picture to be reproduced. The housing 4 is provided at a rear side with jacks for the A/V input and output 11, 12, the USB port 13, and a car 12V DC power supply. To provide the car A/V playback device of the present invention with best shock-absorbing ability and to enable quick mounting and dismounting of the device to and from a car, a socket 5 may be further provided on the car for receiving the whole housing 4 therein. The socket 5 includes a front side formed into an opening, via which the housing 4 is mounted into the socket 5, and a rear side having plugs corresponding to the jacks on the rear side of the housing 4 for the A/V input and output 11, 12, the USB port 13, and the car 12V DC power supply. The plugs on the rear side of the socket 5 are separately electrically connected at another end to multimedia devices, such as display, loudspeakers, etc., provided on the car. With these arrangements, the housing 4 is quickly electrically connected or disconnected at the instant it is inserted into or ejected from the socket 5.

There are three levels of shock-absorbing structure provided for the car A/V playback device of the present invention. The first one is provided between the socket 5 and the car, the second one is between the housing 4 and the socket 5, and the third one is between the hard disk (that is, the data-access unit 2) inside the housing 4 and a magnetic head for reading data from the hard disk. These three levels of shock-absorbing structure thoroughly eliminate the problems existed in the conventional A/V playback equipment on car due to insufficient shock-absorbing structure thereof. Moreover, the car A/V playback device of the present invention is systematically integrated through the microprocessor of the control unit 3 to achieve a miniaturization thereof. More specifically, the car A/V playback device of the present invention has width and length not exceeding that of four cigarette packs and a height not exceeding that of two cigarette packs to facilitate mounting of the device in a car that has only limited internal space. The small size of the car A/V playback device of the present invention also enables convenient mounting, dismounting, and carrying thereof.

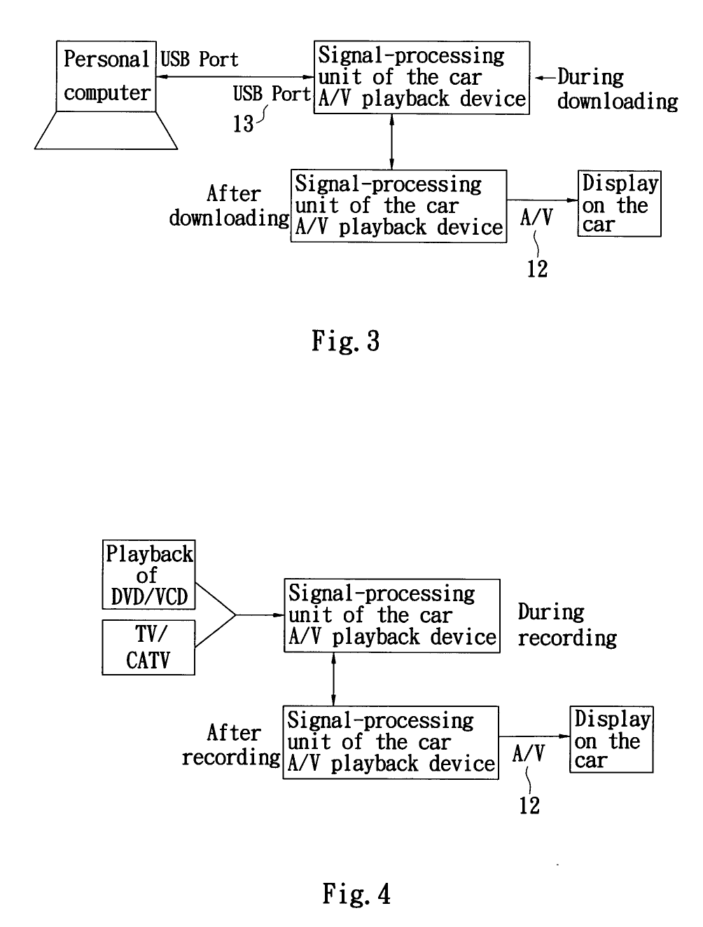

FIG. 3 shows an example of operation of the car A/V playback device of the present invention. As shown, the car A/v playback device may be connected at the USB port 13 to a corresponding USB port 13 on a personal computer (PC) to directly copy A/V data stored in the PC to the car A/V playback device. The control unit 3 of the car A/V playback device sends out control signals that enable data in the PC to store in the hard disk of the playback device via the USB ports 13 without the need of decompressing the A/V signals. And, the A/V signals can be stored in different zones of the hard disk of the playback device according to their types. To select any A/V data stored in the hard disk of the car A/V playback device for playback, a user may first designate a desired block on the hard disk. The A/V signals in the designated block are then decompressed by the signal-processing unit 1 and reduced to the original A/V signals, which are sent via the A/V output 12 to the display mounted on the car and be reproduced.

FIG. 4 shows another example of operation of the car A/V playback device of the present invention. As shown, the car A/V playback device may be connected at the A/V input 11 to a VCD player, a DVD player, or a cable TV (CATV), and the control unit 3 in the car A/V playback device would do real-time storing or recording of A/V data stored on the VCD, DVD, or CATV. When the A/V signals are processed at the signal-processing unit 1, they are compressed and stored in a designated block on the hard disk of the car A/V playback device. And, when a block on the hard disk is designated to reproduce the data previously recorded thereon, the data, which has been previously compressed, will be decompressed by the signal-processing unit 1 and sent via the A/V output 12 to the display for playback. During recording, the car A/V playback device also allows a user to play back a front half of the recorded A/V signals to check for the quality or effect thereof. Or, the user may set the car A/V playback device to start recording at a predetermined time without missing any good program.

In brief, a user may download from a personal computer or a cable television a large quantity of musical works, either in the form of MP3 or CD, TV programs, and VCD and DVD pictures to the car A/V playback device of the present invention. The hard disk of the car A/V playback device of the present invention may be divided into a picture and a music zone. When a picture or musical work being stored has a capacity larger than the capacity that is currently available on the hard disk, the previously stored A/V data would be overwritten by the picture or musical work stored latter. That is, data is stored on the hard disk of the car A/V playback device of the present invention based on the first-in-first-out principle. When the car A/V playback device is used with other A/V peripheral facilities on the car, the user may enjoy pictures and musical works on the car without the need of providing VCD and/or DVD players in the car. As having been mentioned above, the microprocessor included in the present invention is powerful and capable of systematically integrating the car A/V playback device to largely reduce the size thereof, enabling the playback device to be easily mounted on and dismounted from a car and be conveniently carried.

What is claimed is:

1. A car A/V playback device, comprising at least:
a signal-processing unit capable of compressing and storing A/V signals input thereto, and decompressing and outputting A/V signals stored therein for playback;
a data-access unit allowing said signal-processing unit to do real-time access of signals stored on said data-access unit; and
a control unit for controlling modes in which said signal-processing unit and said data-access unit processing A/V signals;
whereby said car A/V playback device can be connected to other multimedia facilities to download and store A/V data and to reproduce stored A/V data directly on a car.

2. The car A/V playback device as claimed in claim 1, wherein said signal-processing unit includes an A/V input, an A/V output, and a USB port for electrically connecting to external peripherals to input and store as well as to output and reproduce A/V signals.

3. The car A/V playback device as claimed in claim 1, wherein said data-access unit is a high-capacity hard disk internally divided into a music, a picture, and a driver zone.

4. The car A/V playback device as claimed in claim 1, wherein said device includes a front panel on which a plurality of function keys are provided for a user to operate and thereby select a stored musical work or picture for playback.

5. The car A/V playback device as claimed in claim 1, wherein said device includes a front panel on which an infrared receiver is provided for a user to control said device with an infrared remote controller in selecting a stored musical work or picture for playback.
